(19) United States
(12) Patent Application Publication
(10) Pub. No.: US 2015/0016482 A1
(43) Pub. Date: Jan. 15, 2015

(54) QUALITY DETECTION DEVICE FOR LASER SOURCE AND THE QUALITY DETECTION METHOD THEREOF

(71) Applicant: EverDisplay Optronics (Shanghai) Limited, Shanghai (CN)

(72) Inventor: Chengshih HUANG, Shanghai (CN)

(73) Assignee: EverDisplay Optronics (Shanghai) Limited, Shanghai (CN)

(21) Appl. No.: 14/103,512

(22) Filed: Dec. 11, 2013

(30) Foreign Application Priority Data
Jul. 9, 2013 (CN) 201310287546.5

(51) Int. Cl. H01S 3/00

(52) U.S. Cl. CPC H01S 3/005
USPC 372/38.09

(57) ABSTRACT

The disclosure provides a quality detection device for laser source and the quality detection method thereof. The laser source quality detection device comprises: a reflective mirror set located in a range of emitting light from the laser source for receiving light beams from the laser source, and having at least one reflective mirror to reflect the light emitted from the laser source in a profile the same as that of the light emitted from the laser source; and at least one sensor capable of receiving the reflected light out of a predetermined range so as to determine quality of the laser source.

### CROSS-REFERENCE TO RELATED APPLICATIONS

This application claims the benefits of Chinese Patent Application No. 201310287546.5, filed on Jul. 9, 2013 in the Patent Office of China, the disclosure of which is incorporated herein by reference in its entirety.

### TECHNICAL FIELD

The present disclosure relates in general to a quality detection device for gaseous laser source and a detection method thereof, and, in particular, to a device and method for the excimer laser.

### BACKGROUND ART

Excimer laser technology is widely used in industry, and it has high demand on the quality of the laser source in the polysilicon tempering process for manufacturing panels. For example, after using gaseous laser source for a period of time, the light generated from the initial laser raw beam will be diverged or deviated due to electrode oxidation and other factors. FIGS. 1 and 2 show a schematic diagram of normal laser beam and the energy curve graph thereof, and, FIGS. 4 and 5 show a schematic diagram of laser beam with diverged light and the energy curve graph thereof. It can be seen that the light energy of laser beam with diverged light is distorted or attenuated, which will lead to that energy of the laser beam scanning on products subsequently is affected. Furthermore, if light is deviated, as shown in FIG. 3, the light received in products will also be deviated, and then the products cannot be scanned normally. Therefore, quality of laser source, including whether divergence or deviation occurs, will affect the yield of products.

One quality detection method for laser source is that: detecting whether the products are abnormal, and determining whether the laser source has quality defect through the above detecting result.

However, the above method is passive, which only can judge a quality problem for the light source after the defect in a product is detected, and then shut down the machine to handle it. Thus, it will affect manufacturing efficiency, decrease the yield of products, and increase manufacturing cost.

Therefore, it needs a quality detection device for laser source and a detection method thereof so as to find the abnormal initial laser light in advance and perform adjustment and overhaul in time, and improve processing efficiency.

The above information disclosed in this Background section is only for enhancement of understanding of the background of the disclosure and therefore it may contain information that does not form the prior art that is already known in this country to a person of ordinary skill in the art.

### SUMMARY OF INVENTION

The present disclosure provides a quality detection device for laser source and a detection method thereof, so as to find abnormal initial laser light in advance and improve processing efficiency.

Additional aspects and advantages will be set forth in part in the description which follows and, in part, will be apparent from the description, or may be learned by practice of the disclosure.

According to one aspect of the disclosure, a quality detection device for a laser source is disclosed, which comprises: a reflective mirror set located in a range of emitting light from the laser source for receiving light beams from the laser source, and having at least one reflective mirror to reflect the light emitted from the laser source in a profile the same as that of the light emitted from the laser source; and at least one sensor capable of receiving the reflected light out of a predetermined range so as to determine quality of the laser source.

Wherein the reflective mirror set comprises a plurality of reflective mirrors.

Wherein transmissivity of the reflective mirror set and number of the reflective mirrors are adapted to adjust according to photosensitivity of the at least one sensor.

Wherein the reflective mirror set has a low reflectivity and a high transmissivity.

Wherein the at least one sensor is a fiber optical sensor capable of obtaining a small amount of light from abnormal light source.

Wherein the at least one sensor is a thermal sensor or a light sensor.

The laser source quality detection device further comprises an alarm capable of sending out a signal indicating abnormality of the laser source when the at least one sensor picks up the reflected light.

Wherein the laser source is a rectangle laser source, and two sensors are symmetrically provided.

Wherein the laser source is a circle laser source, four sensors are uniformly provided.

Wherein the laser source is a gaseous laser source.

According to one aspect of the disclosure, a quality detection device for a laser source is disclosed, the layer source is normal or abnormal; the quality detection device is capable of detecting whether the laser source is abnormal, wherein, the quality detection device is located at an exit for a light beam of the laser source and comprises: a reflective mirror set located in a range of emitting light from the laser source for receiving light beams from the laser source, and comprising at least one reflective mirror, wherein, the light emitted from the laser source is reflected by the reflective mirror set, and the reflected light is projected at a side of the exit for the light beam with a same profile as that of the light emitted from the laser source; and at least one sensor located at a periphery of the range of a normal light defined by the exit for the light beam, wherein the at least one sensor is capable of receiving the reflected light if the reflected light is out of the range of the normal light, so as to determine that the laser source is abnormal.

According to another aspect of the disclosure, a quality detection method for a laser source is disclosed. the layer source is normal or abnormal; the quality detection method is used to detect whether the laser source is abnormal, and the method comprises the following steps:

Step 1: providing a reflective mirror set and at least one sensor at the exit for a light beam of the laser source;

Step 2: turning on the laser source to be detected, such that all the light emitted from the laser source is projected on the reflective mirror set, and the light reflected by the reflective mirror set is projected at a side of the exit for the light beam with a same profile as the that of the light emitted from the laser source; and

Step 3: if the reflected light is out of a range of a normal light defined at the exit for the light beam, then the at least one sensor receives the reflected light to determine that the laser source is abnormal.

In conclusion, the quality detection device for laser source and detection method thereof according to the present disclosure can determine the abnormal light source in advance, thus provide early warning in time, achieve a quality control with high efficiency and reduce labor power loss. In addition, the quality detection device for laser source according to the present disclosure has a simple structure and lower manufacturing costs.

### BRIEF DESCRIPTION OF THE DRAWINGS

The foregoing and other features and advantages of the disclosure will be apparent to those skilled in the art in view of the following detailed description, taken in conjunction with the accompanying drawings.

FIG. 1 illustrates a schematic diagram of a normal laser beam.

FIG. 2 illustrates an energy curve diagram of a normal laser beam.

FIG. 3 illustrates a schematic diagram of a laser beam with deviated light.

FIG. 4 illustrates a schematic diagram of a laser beam with diverged light.

FIG. 5 illustrates an energy cure diagram of a laser beam with diverged light.

FIG. 6 illustrates a schematic diagram of the quality detection device for laser source according to the first embodiment of the disclosure.

FIG. 7 illustrates a schematic diagram of performing detection by using the quality detection device for laser source according to the first embodiment, wherein, the laser source is normal.

FIG. 8 illustrates a schematic diagram of performing detection by using the quality detection device for laser source according to the first embodiment, wherein, the laser source is deviated.

FIG. 9 illustrates a schematic diagram of performing detection by using the quality detection device for laser source according to the first embodiment, wherein, the laser source is diverged.

FIG. 10 illustrates a schematic diagram of performing detection by using the quality detection device for laser source according to the second embodiment, wherein, the laser source is normal.

FIG. 11 illustrates a schematic diagram of performing detection by using the quality detection device for laser source according to the third embodiment, wherein, the laser source is normal.

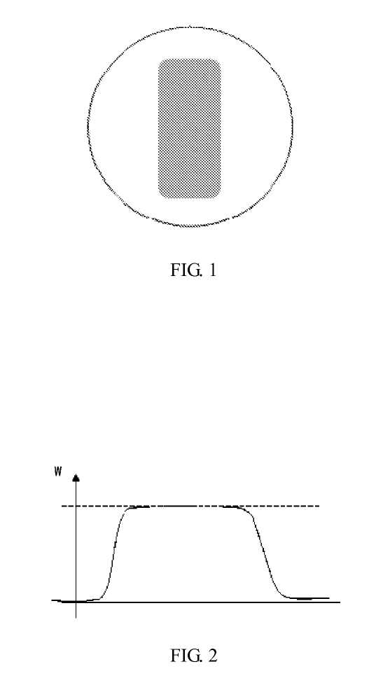

### DETAILED DESCRIPTION

Exemplary embodiments of the disclosure will now be described more fully with reference to the accompanying drawings, in which exemplary embodiments are shown. Exemplary embodiments of the disclosure may, however, be embodied in many different forms and should not be construed as being limited to the embodiments set forth herein; rather, these embodiments are provided so that this disclosure will be thorough and complete, and will fully convey the concept of exemplary embodiments to those skilled in the art. In the drawings, the thicknesses of layers and regions are exaggerated for clarity. Like reference numerals in the drawings denote like elements, and thus their description will be omitted.

The described features, structures, or/and characteristics of the disclosure may be combined in any suitable manner in one or more embodiments. In the following description, numerous specific details are disclosed to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

### The First Embodiment

A laser source quality detection device comprises: a reflective mirror set located in a range of emitting light from the laser source for receiving light beams from the laser source, and having at least one reflective mirror to reflect the light emitted from the laser source in a profile the same as that of the light emitted from the laser source; and at least one sensor capable of receiving the reflected light out of a predetermined range so as to determine quality of the laser source.

In this embodiment, a quality detection device 10 for laser source is provided.

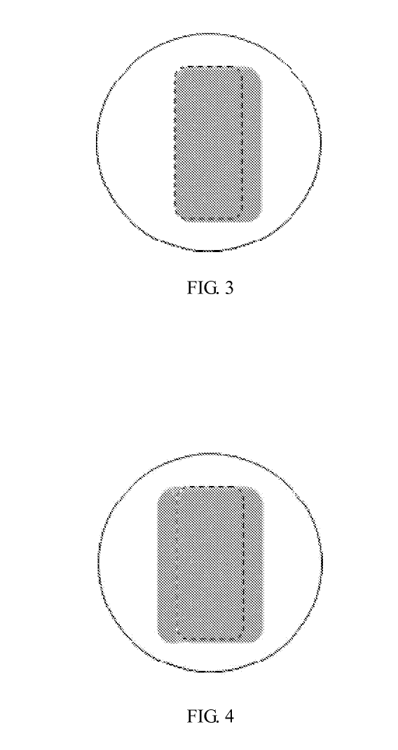

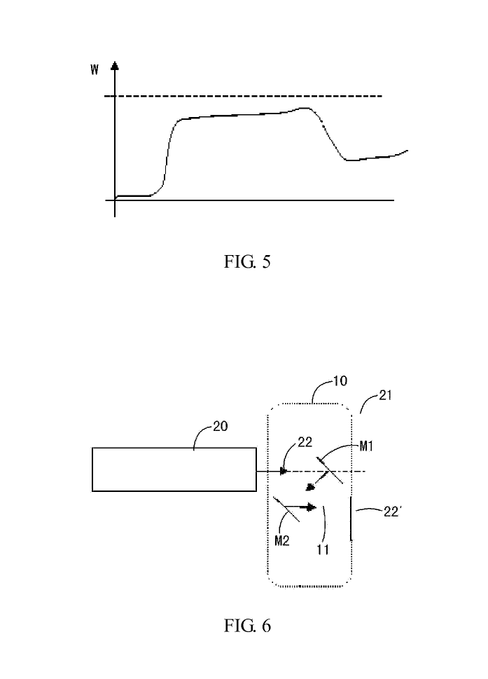

The laser source 20 may be normal or abnormal, and the quality detection device for laser source 10 is used to detect whether the laser source is abnormal. The abnormal laser source may include a light source with deviated or diverged light as shown in FIG. 3 or FIG. 4 respectively. In this embodiment, the laser source 20 is a rectangle gaseous laser source, the wavelength of which is about 200˜400 nm.

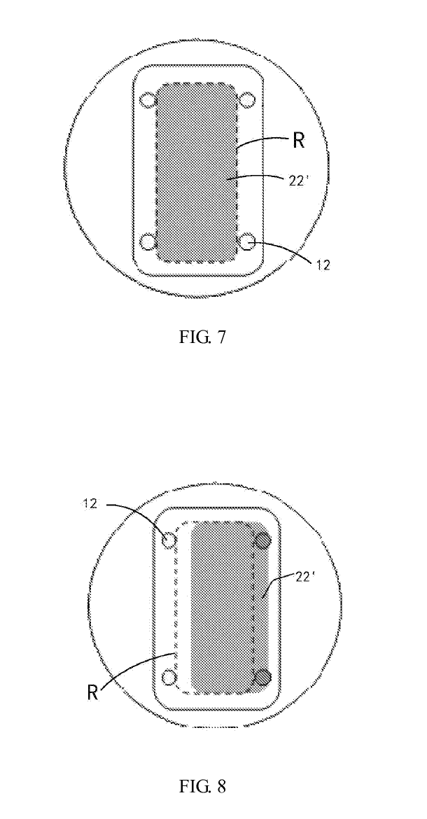

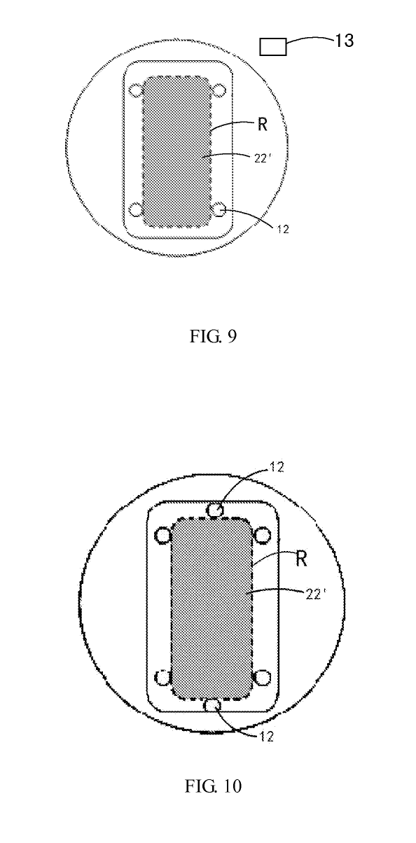

As shown in FIG. 6, the quality detection device 10 is located at the exit for the light beam of a laser source 21. As shown in FIGS. 6 and 7, the quality detection device 10 comprises a reflective mirror set 11 and sensor 12. The reflective mirror set 11 is located in the range of the light from the laser source for receiving all light beams from the laser source. The reflective mirror set 11 comprises at least one reflective mirror. In this embodiment, the reflective mirror set comprises a first reflective mirror M1 and a second reflective mirror M2. All the light from the laser source 22 is projected on the first reflective mirror M1, a part of which transmits through the first reflective mirror M1, and another part of which reflects off the first reflective mirror M1, and the reflected light is projected on the second reflective mirror M2. In the same way, a part of the reflected light transmits through the second reflective mirror M2, and another part of the reflected light reflects off the second reflective mirror M2. Because the shape of the light source does not change after several reflections, the reflected light 22′ reflected by the second reflective mirror M2 has the same shape and size with that of the light 22 emitting from the laser source, which is in the shape of rectangle, and is projected on the side of the exit 21 for the light beam of a laser source 21. As shown in FIG. 7, the range R of a normal light is defined at side of the exit 21 for the light beam of a laser source, which has the same shape and size with that of the normal light 22 emitting from the laser source and has the same location with that of the reflected light beam from a normal laser source by the reflective mirror set 11. Therefore, if the laser source is normal, then the reflected light 22′ will not be out of the range R of a normal light, as shown in FIG. 7. If the laser source is abnormal, then at least part of the reflected light 22′ will be out of the range R of a normal light. For example, if the laser source is deviated, then the relation between the reflected light 22′ and the range R of a normal light may be as indicated in FIG. 8. If the laser source is diverged, then the relation between the reflected light 22′ and the range R of a normal light may be as indicated in FIG. 9. The sensors 12 are provided at the periphery of the range R of a normal light. In this embodiment, two sensors 12 are symmetrically provided. In particular, the two sensors 12 are symmetrically provided outside two long sides of the rectangular range R of a normal light, respectively.

Therefore, the sensors 12 can receive the abnormal light beam reflected by the reflective mirror set 11 once the laser source become abnormal, and thus determine that laser source is abnormal.

This embodiment is described with the example that the reflective mirror set includes two reflective mirrors. It should be understood, the number of reflective mirrors are adapted to be adjusted according to the photosensitivity of the sensor. Of course, the location of the range R of a normal light can also be adjusted accordingly, which should be consistent with the location of the reflected light beam from a normal laser source reflected by the reflected set.

Additionally, reflectivity and transmissivity of the reflective mirror set can also be adjusted. For example, a reflective mirror with low reflectivity and high transmissivity may be employed, such that the intensity of the laser source received by the sensor can be reduced by a greater degree.

For example, the trasmissivity of the reflective mirror set is 98%˜99% and the reflectivity is 1%˜2%, therefore among the light beam received by the reflective mirror set, 98%˜99% transmits through the reflective mirror set and only 1%˜2% is reflected to the sensor, such that the sensor 12 can avoid exposing to the light having high energy. Therefore, the present disclosure can use sensors with lower cost instead of high cost sensors, which are used to sense high energy. In a similar way, the sensor can also be a thermal sensor and a light sensor.

In addition, as shown in FIG. 9, this device may further include an alarm 13. The alarm is capable of sending out a signal indicating abnormality of the laser source when the at least one sensor picks up the reflected light. In particular, when the sensor 12 senses the light source is abnormal, a signal is sent to the alarm indicating the laser source is abnormal, and the alarm sends out an alert or a shutdown signal.

The present device is located at the side of the exit for the light beam of the laser source, thus an early warning can start from the initial light source. As for the related art, a quality problem can be determined only after an abnormal case of products is found, which is different from the present disclosure and will affect the processing efficiency.

Therefore, the present disclosure can find an abnormal case of the light source in advance, thus improve detection efficiency, and adjust in time so as to reduce a risk of adjustment to the backend means such as the optical module for receiving light beams and a loss of labor power.

In addition, after reflected by the reflective mirror set 11, the energy of the light with higher energy is reduced, and then it is received by the sensor 12, such that the sensor 12 can avoid exposing to the light having higher energy. Therefore, the present disclosure can use sensors with lower cost instead of high cost sensors that is used to sense high energy, thus the cost can be reduced significantly.

### The Second Embodiment

As shown in FIG. 10, the structure according to the second embodiment is substantially the same as that of the first embodiment except for the difference that one sensor 12 is provided outside of two short sides of the rectangular range R of a normal light, respectively, i.e., the sensors 12 are provided around the range R of a normal light, such that it can detect an abnormal light deviation in all directions.

### The Third Embodiment

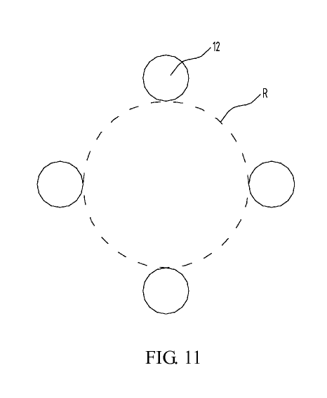

As shown in FIG. 11, the structure according to third embodiment and the first embodiment are basically the same except for the difference that the laser source is in the shape of a circle, four sensors 12 are uniformly provided, especially uniformly provided at the exit of the light beam of the light source and arranged uniformly along the circumference of the circular range R of a normal light.

In addition, the present disclosure still provides a quality detection method for laser source, the laser source may be normal or abnormal. The quality detection method for light source is used to detect whether this light source is abnormal. The method includes the following steps:

Step 1: providing a reflective mirror set and sensors at the exit for the light beam of the laser source;

Step 2: turning on the laser source to be detected, such that all the light emitting from the laser source is projected to the reflective mirror set, and the light reflected by the reflective mirror set is projected at the side of the exit for the light beam with the same profile as that of the light emitted from laser source; and

Step 3: if the reflected light is out of the range of a normal light defined at the exit for the light beam, the sensors receive this reflected light so as to determine that the laser source is abnormal.

If the laser source is normal, then the reflected light will not go beyond the range of a normal light, thus the sensor cannot receive this reflected light.

This method may further include step 4: after the sensors receive the reflected light, sending a signal to an alarm indicating the laser source is abnormal, and the alarm sends out an alert or a shutdown signal.

As described above, the quality detection device for laser source according to the present disclosure can determine the abnormal light source in advance, thus provide early warning in time, achieve a quality control with high efficiency and reduce labor power loss. Moreover, the disclosure has a simple structure and a lower manufacturing cost.

Exemplary embodiments have been specifically shown and described as above. It will be appreciated by those skilled in the art that the disclosure is not limited the disclosed embodiments; rather, all suitable modifications and equivalent which come within the spirit and scope of the appended claims are intended to fall within the scope of the disclosure.

What is claimed is:

1. A laser source quality detection device comprising:
a reflective mirror set located in a range of emitting light from the laser source for receiving light beams from the laser source, and having at least one reflective mirror to reflect the light emitted from the laser source in a profile the same as that of the light emitted from the laser source; and
at least one sensor capable of receiving the reflected light out of a predetermined range so as to determine quality of the laser source.

2. The laser source quality detection device according to claim 1, wherein the reflective mirror set comprises a plurality of reflective mirrors.

3. The laser source quality detection device according to claim 1, wherein, transmissivity of the reflective mirror set and number of the reflective mirrors are adapted to adjust according to photosensitivity of the at least one sensor.

4. The laser source quality detection device according to claim 3, wherein, the reflective mirror set has a low reflectivity and a high transmissivity.

5. The laser source quality detection device according to claim 1, wherein, the at least one sensor is a fiber optical sensor capable of obtaining a small amount of light from abnormal light source.

6. The laser source quality detection device according to claim 1, wherein the at least one sensor is a thermal sensor or a light sensor.

7. The laser source quality detection device according to claim 1 further comprising an alarm capable of sending out a signal indicating abnormality of the laser source when the at least one sensor picks up the reflected light.

8. The laser source quality detection device according to claim 1, wherein the laser source is a rectangle laser source, and two sensors are symmetrically provided.

9. The laser source quality detection device according to claim 1, wherein, the laser source is a circle laser source, four sensors are uniformly provided.

10. The laser source quality detection device according to claim 1, wherein, the laser source is a gaseous laser source.
